(19) United States
(12) Patent Application Publication
(10) Pub. No.: US 2013/0100070 A1
(43) Pub. Date: Apr. 25, 2013

(54) STYLUS, TOUCH SENSITIVE DISPLAY SYSTEM AND TOUCH SENSITIVE DISPLAY METHOD

(71) Applicants: Zao-Shi Zheng, Kaohsiung City (TW); Chun Chang, Kaohsiung City (TW); An-Thung Cho, Hualien County (TW); Jiun-Jye Chang, Hsinchu City (TW)

(72) Inventors: Zao-Shi Zheng, Kaohsiung City (TW); Chun Chang, Kaohsiung City (TW); An-Thung Cho, Hualien County (TW); Jiun-Jye Chang, Hsinchu City (TW)

(73) Assignee: AU OPTRONICS CORPORATION, Hsinchu (TW)

(21) Appl. No.: 13/350,800

(22) Filed: Jan. 15, 2012

(30) Foreign Application Priority Data
Oct. 25, 2011 (TW) 100138635

(51) Int. Cl. G06F 3/033; G06F 3/045; G06F 3/042

(52) U.S. Cl. 345/174; 345/179; 345/175

(57) ABSTRACT

A stylus, a touch sensitive display system, and a touch sensitive display method are provided. A pressure sensing material is disposed in the stylus for sensing a force exerted by a user and feeding the force back to a touch sensitive display panel, so as to adjust an appearance of a display image (e.g., a width of a line or a gray level of the line) and provide diverse touch sensitive display effects.

### CROSS-REFERENCE TO RELATED APPLICATION

This application claims the priority benefit of Taiwan application serial no. 100138635, filed on Oct. 25, 2011. The entirety of the above-mentioned patent application is hereby incorporated by reference herein and made a part of this specification.

### BACKGROUND OF THE INVENTION

1. Field of the Invention

The disclosure relates to a touch sensitive display technology. More particularly, the invention relates to a touch sensitive display technology that can reflect a stroke of a light pen.

2. Description of Related Art

In recent years, the touch sensitive panels have created a sensation in the market, and the development of the “touch panel integration on glass” structure of the existing touch sensitive display panels is directed to integration of photo sensors on a thin film transistor (TFT) array, so as to obtain a TFT liquid crystal display (LCD) panel capable of sensing light. A stylus applicable to the touch sensitive display panel has an internal light source and thus can emit light. When the stylus is employed to perform a touch sensing operation on the touch sensitive display panel, the photo sensors in the touch sensitive display panel can sense the light and thereby detect the touch location.

However, the stylus emitting the light is utilized to merely achieve a positioning effect, a selection effect, and a normal hand-writing effect on the existing optical touch sensitive panel characterized by “touch panel integration on glass”. The optical touch sensitive panel does not have any effective feedback mechanism in response to the stroke of the stylus for identifying the magnitude of a hand-writing or painting force of a user. Accordingly, the stroke of the stylus remains consistent without changes in tones or thickness.

### SUMMARY OF THE INVENTION

The invention is directed to a stylus that is applicable to a touch sensitive display panel. By applying the stylus, the magnitude of a hand-writing force exerted by a user can be fed back to the touch sensitive display panel, so as to adjust an appearance of a display image (e.g., a width of a line or a gray level of a line) and thereby provide diverse touch sensitive display effects.

The stylus includes a handle, a head, a pressure sensing material, and a light emitting device. The head is located at one end of the handle for touching the touch sensitive display panel. The pressure sensing material is disposed in the handle for receiving a feedback pressure generated by touching the touch sensitive display panel with the head. When the pressure sensing material receives the feedback pressure, the pressure sensing material is suitable for being deformed and generates an electrical variation. The light emitting device is located in the handle for emitting light to the touch sensitive display panel. The light emitting device is electrically connected to the pressure sensing material, and a driving current of the light emitting device responds to the electrical variation. For instance, the driving current of the light emitting device is positively or negatively correlated with the electrical variation of the pressure sensing material.

The invention is further directed to a touch sensitive display system to which the aforesaid stylus is applicable. By applying the stylus, the magnitude of a hand-writing force exerted by a user can be fed back to the touch sensitive display panel, so as to adjust an appearance of a display image (e.g., a width of a line or a gray level of a line) and thereby provide diverse touch sensitive display effects.

The touch sensitive display system includes the touch sensitive display panel and the stylus. The touch sensitive display panel has a photosensitive module for receiving the light emitted from the stylus. The head of the stylus is suitable for touching the touch sensitive display panel along a trace, and the touch sensitive display panel displays an image corresponding to the trace. The driving current of the light emitting device responds to the electrical variation. Therefore, the intensity of the light emitted from the stylus is changed together with variations in the magnitude of the driving current, and the photosensitive module can adjust the appearance of the image based on the intensity of the light received by the photosensitive module.

The invention is further directed to a touch sensitive display method applicable to the touch sensitive display system. Specifically, the touch sensitive display method includes: generating a feedback pressure by touching a touch sensitive display panel with a stylus to deform a pressure sensing material and thereby generating an electrical variation; coupling the electrical variation to a driving current of a light emitting device to adjust intensity of light; adjusting an appearance of an image according to the intensity of the light.

The invention is further directed to a touch sensitive display system suitable for feeding back a hand-writing force exerted by a user to a touch sensitive display panel in a wireless manner or through a wire, so as to adjust an appearance of a display image (e.g., a width of a line or a gray level of a line) and thereby provide diverse touch sensitive display effects. The touch sensitive display system includes a touch sensitive display panel, a stylus, and a calculation apparatus. The stylus includes a handle, a head, a pressure sensing material, and a wireless transmission module or a wire transmission module. The head is located at one end of the handle for touching the touch sensitive display panel along a trace. The touch sensitive display panel is suitable for displaying an image corresponding to the trace. The pressure sensing material is disposed in the handle for receiving a feedback pressure generated by touching the touch sensitive display panel with the head. Besides, the pressure sensing material, when receiving the feedback pressure, is deformed and thereby generates an electrical variation. The wireless transmission module is electrically connected to the pressure sensing material for receiving the electrical variation. The calculation apparatus is electrically connected to a touch sensitive display device and is suitable for receiving the electrical variation from the wireless transmission module in a wireless manner and adjusting an appearance of the image according to the electrical variation.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a touch sensitive display system according to an embodiment of the invention.

FIG. 2A and FIG. 2B illustrate an inner structure of the stylus depicted in FIG. 1 and the touch sensitive display system in different states when different forces are exerted.

FIG. 3 is an equivalent circuit diagram of the stylus in FIG. 2A and FIG. 2B.

FIG. 4 illustrates a touch sensitive display method applicable to the touch sensitive display system depicted in FIG. 2A and FIG. 2B.

FIG. 5A and FIG. 5B illustrate an inner structure of a stylus and a touch sensitive display system in different states when different forces are exerted according to another embodiment of the invention.

FIG. 6 is an equivalent circuit diagram of the stylus in FIG. 5A and FIG. 5B.

FIG. 7 illustrates a touch sensitive display method applicable to the touch sensitive display system depicted in FIG. 5A and FIG. 5B.

FIG. 8 is an equivalent circuit diagram of a stylus according to another embodiment of the invention.

FIG. 9 is an equivalent circuit diagram of a stylus according to another embodiment of the invention.

FIG. 10 illustrates a touch sensitive display system according to another embodiment of the invention.

### DESCRIPTION OF EMBODIMENTS

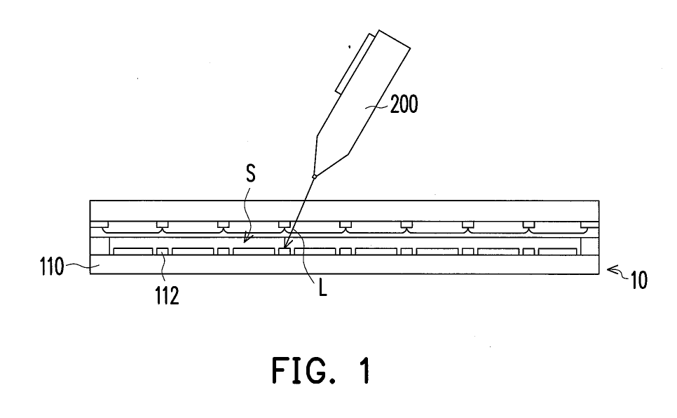

FIG. 1 illustrates a touch sensitive display system according to an embodiment of the invention. The touch sensitive display system includes a touch sensitive display panel 10 and a stylus 200. The touch sensitive display panel 10 has a structure of “touch panel integration on glass”, and its TFT array substrate 110 has a photosensitive module (e.g., photo sensors 112) disposed thereon. The photo sensors 112 are respectively configured in pixel regions S in the touch sensitive display panel 10.

When the stylus 200 is employed to perform a touch sensing operation on the touch sensitive display panel 10, the stylus 200 can emit light L, and the photo sensors 112 in the touch sensitive display panel 10 can sense the light L and thereby detect the touch location.

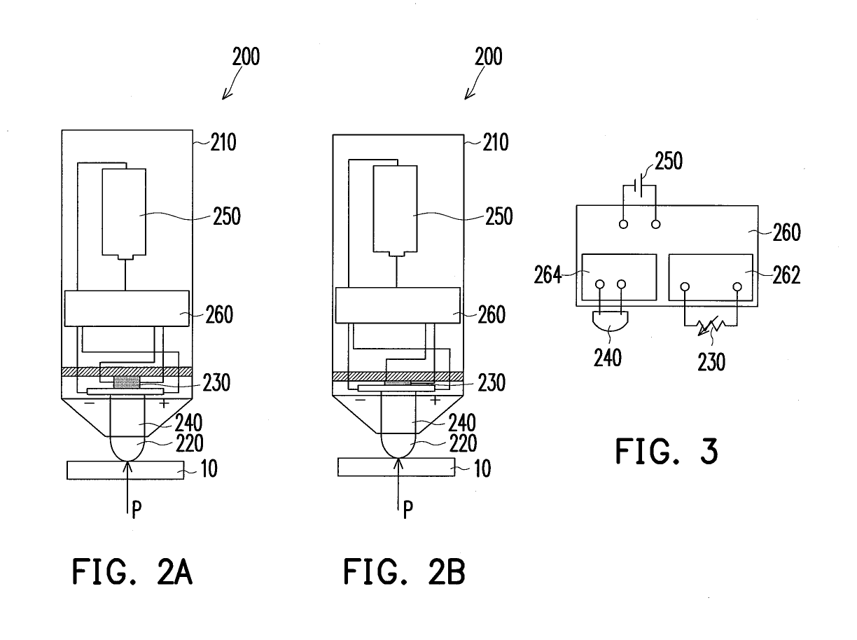

FIG. 2A and FIG. 2B illustrate an inner structure of the stylus 200 and the touch sensitive display system in different states when different forces are exerted. FIG. 3 is an equivalent circuit diagram of the stylus 200. The stylus 200 includes a handle 210, a head 220, a pressure sensing material 230, a light emitting device 240, a power supply 250, and a control module 260. The head 220 is located at one end of the handle 210 for touching the touch sensitive display panel 10. The light emitting device 240 is, for instance, a light emitting diode (LED) for emitting the light L to the touch sensitive display panel 10. The photo sensors 112 are suitable for receiving the light L, and an image (a line) corresponding to a trace of the head 220 on the touch sensitive display panel 10 is displayed on the touch sensitive display panel 10.

The pressure sensing material 230 is disposed in the handle 210 and leans against the head 220 for receiving a feedback pressure P generated by touching the touch sensitive display panel 10 with the head 220. When the pressure sensing material 230 receives the feedback pressure P, the pressure sensing material 230 is suitable for being deformed (e.g., compressed) and generates an electrical variation. The pressure sensing material 230 of this embodiment is a piezoresistive material, for instance. That is to say, when an external force is exerted on the pressure sensing material 230, and the pressure sensing material 230 is deformed, the impedance of the pressure sensing material 230 is varied.

The control module 260 is electrically connected to the light emitting device 240 and the pressure sensing material 230 and includes an amplifying and analyzing circuit 262 and a driving circuit 264, for instance. When an external force is exerted on the pressure sensing material 230, and the impedance of the pressure sensing material 230 is varied, the amplifying and analyzing circuit 262 of the control module 260 analyzes the impedance variation, and the driving output 264 outputs the corresponding driving current to the light emitting device 240. In other words, the control module 260 of this embodiment can adjust the driving current output to the light emitting device 240 according to the impedance variation, such that the driving current of the light emitting device 240 responds to the impedance variation of the pressure sensing material 230. For instance, the driving current of the light emitting device 240 may be positively or negatively correlated with the impedance variation of the pressure sensing material 230.

On the other hand, the intensity of the light L emitted from the light emitting device 240 is changed together with variations in the magnitude of the driving current, and the photo sensors 112 can transmit the change in intensity of the light L received by the photo sensors 112 back to the touch sensitive display panel 10. Thereby, the hand-writing force exerted by the user is fed back to the touch sensitive display panel 10, so as to adjust an appearance of a display image, e.g., a width of a line or a gray level of a line.

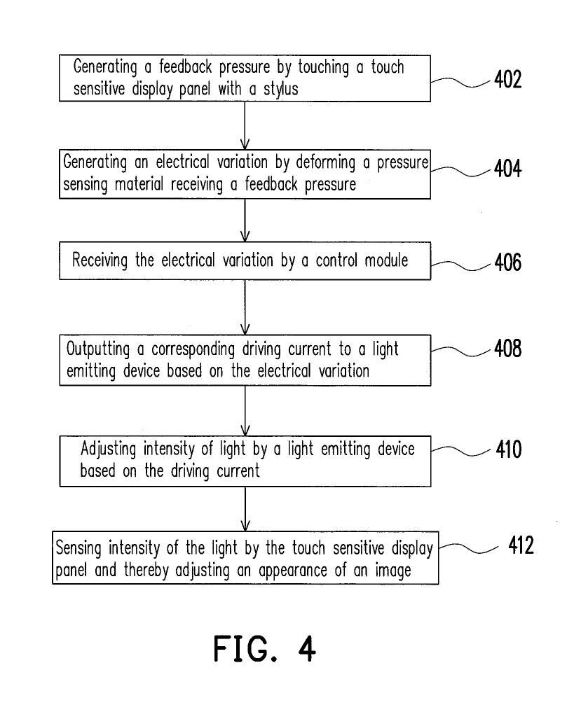

Based on the above, the touch sensitive display method described in the previous embodiment is shown in FIG. 4. First, in step 402, the stylus touches the touch sensitive display panel and generates a feedback pressure. In step 404, the pressure sensing material receives the feedback pressure and is then deformed and generates an electrical variation. In step 406, the control module receives the electrical variation; in step 408, the control module outputs the corresponding driving current to the light emitting device according to the electrical variation. In step 410, the light emitting device generates light with the corresponding intensity according to the driving current. In step 412, the touch sensitive display panel senses the intensity of the light and accordingly adjusts the appearance of the image. According to different touch sensitive display requirements, the appearance variation of the image herein may refer to any visual variation. For instance, when the line along the touch trace represents the stroke of the stylus on the touch sensitive display panel, the appearance variation of the image may refer to the change in width or gray level of the line.

As exemplarily shown in FIG. 2A, when a user exerts a small force with the stylus 200 (i.e., the feedback pressure P is small), the deformation of the pressure sensing material 230 is insignificant. Thus, large impedance can be fed back to the control module 260, and the control module 260 determines to output a small driving current to the light emitting device 240. At this time, the intensity of light from the light emitting device 240 is small, and the touch sensitive display panel 10, when sensing the dim light, displays strokes with small width or light color. On the contrary, as exemplarily shown in FIG. 2B, when a user exerts a large force with the stylus 200 (i.e., the feedback pressure P is large), the deformation of the pressure sensing material 230 is significant. Thus, small impedance can be fed back to the control module 260. At this time, the control module 260 determines to output a large driving current to the light emitting device 240, the light emitting device 240 thus transmits the light with great intensity, and the touch sensitive display panel 10, when sensing the intense light, displays strokes with large width or dark color.

In other embodiments of the invention, the control module described in the previous embodiment can be omitted, while the electrical variation of the pressure sensing material can be fed back to the light emitting device through a loop design. Thereby, the design of the stylus can be further simplified, which is conducive to reduction of internal layout space of the stylus and decrease in manufacturing costs. Several possible design schemes are proposed hereinafter.

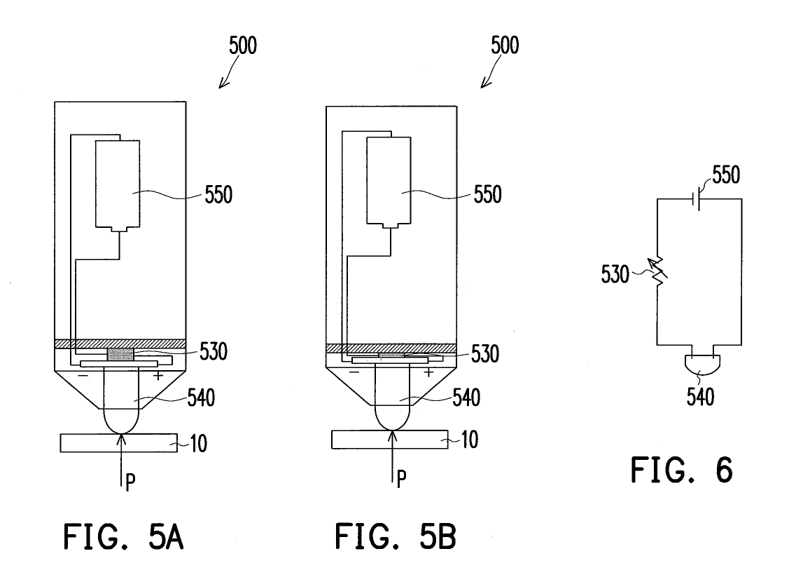

FIG. 5A and FIG. 5B illustrate an inner structure of a stylus 500 and a touch sensitive display system in different states when different forces are exerted according to another embodiment of the invention. FIG. 6 is an equivalent circuit diagram of the stylus 500. The main difference between the stylus 500 of this embodiment and the stylus 200 of the previous embodiment lies in that the control module 260 of the stylus 200 is omitted herein, and that the pressure sensing material 530, the light emitting device 540, and the direct-current (DC) power supply 550 are connected in series on the same loop. The pressure sensing material 530 is a piezoresistive material, for instance. When the piezoresistive material generates the impedance variation, the driving current flowing through the light emitting device 540 is varied, and thereby the intensity of light from the light emitting device 540 is changed as well.

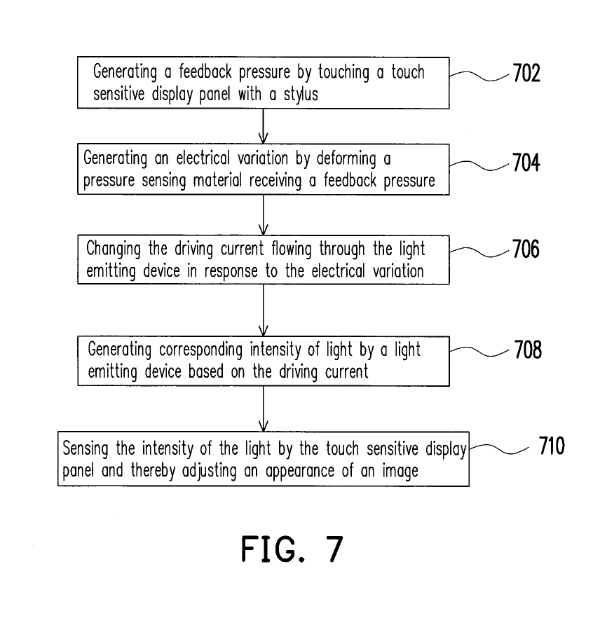

In addition, the touch sensitive display method described in this embodiment is shown in FIG. 7. First, in step 702, the stylus touches the touch sensitive display panel and generates a feedback pressure. In step 704, the pressure sensing material receives the feedback pressure and is then deformed and generates an electrical variation. In step 706, in response to the electrical variation, the driving current flowing through the light emitting device is varied. In step 708, the light emitting device generates light with the corresponding intensity according to the driving current. In step 710, the touch sensitive display panel senses the intensity of the light and accordingly adjusts the appearance of the image. According to different touch sensitive display requirements, the appearance variation of the image herein may refer to any visual variation. For instance, when the line along the touch trace represents the stroke of the stylus on the touch sensitive display panel, the appearance variation of the image may refer to the change in width or gray level of the line.

As exemplarily shown in FIG. 5A, when a user exerts a small force with the stylus 500 (i.e., the feedback pressure P is small), the deformation of the pressure sensing material 530 is insignificant, and impedance of the pressure sensing material 530 generated thereby is large. Thus, in case of a fixed voltage supply 550, the driving current flowing through the light emitting device 540 is small. That is to say, the driving current of the light emitting device 540 is positively correlated with the feedback pressure P of the stylus 500. At this time, the intensity of light from the light emitting device 540 is small, and the touch sensitive display panel 10, when sensing the dim light, displays strokes with small width or light color. On the contrary, as exemplarily shown in FIG. 5B, when a user exerts a large force with the stylus 500 (i.e., the feedback pressure P is large), the deformation of the pressure sensing material 530 is significant, and impedance of the pressure sensing material 530 generated thereby is small. Thus, in case of the fixed voltage supply 550, the driving current flowing through the light emitting device 540 is large. At this time, the intensity of light from the light emitting device 540 is large, and the touch sensitive display panel 10, when sensing the intense light, displays strokes with large width or dark color.

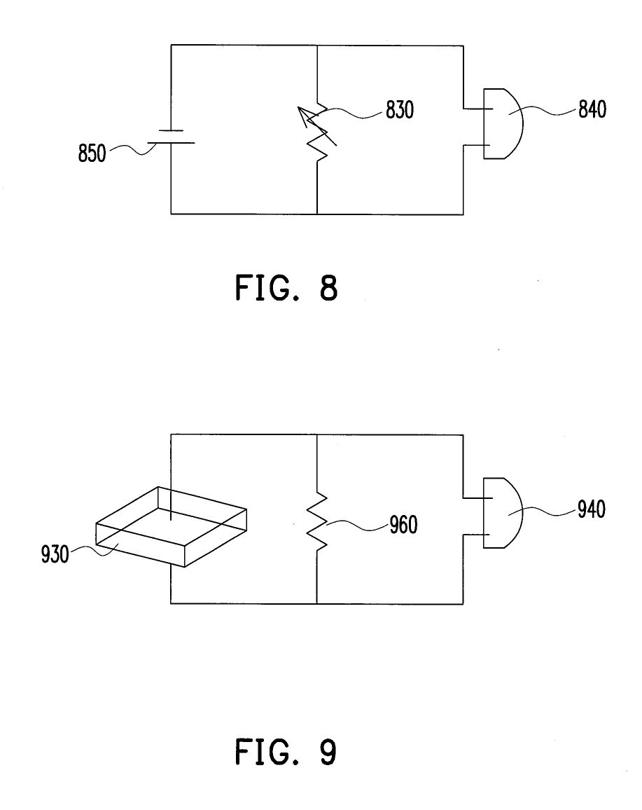

In another embodiment of the invention, the pressure sensing material 530 and the light emitting device 540 of the stylus 500 described in the previous embodiment can be connected in parallel. FIG. 8 is an equivalent circuit diagram of a stylus according to another embodiment of the invention. The main difference between the stylus of this embodiment and the stylus 500 of the previous embodiment lies in that the pressure sensing material 830 and the light emitting device 840 are connected in parallel on a loop of the DC power supply 850. The pressure sensing material 830 is also a piezoresistive material. When the piezoresistive material generates the impedance variation, the driving current flowing through the light emitting device 840 is varied, and thereby the intensity of light from the light emitting device 840 is changed as well.

The touch sensing display method described in this embodiment is similar to that described in the previous embodiment. When a user exerts a small force with the stylus (i.e., the feedback pressure is small), the deformation of the pressure sensing material 830 is insignificant, and impedance of the pressure sensing material 830 generated thereby is large. Thus, in case of a fixed voltage supply 850, the driving current flowing through the light emitting device 840 is large. That is to say, the driving current of the light emitting device 840 is negatively correlated with the feedback pressure of the stylus. At this time, the intensity of light from the light emitting device 840 is large, and the touch sensitive display panel, when sensing the intense light, displays strokes with large width or dark color. By contrast, when a user exerts a large force with the stylus (i.e., the feedback pressure is large), the deformation of the pressure sensing material 830 is significant, and impedance of the pressure sensing material 830 generated thereby is small. Thus, in case of the fixed voltage supply 850, the driving current flowing through the light emitting device 840 is small. At this time, the intensity of light from the light emitting device 840 is small, and the touch sensitive display panel, when sensing the dim light, displays strokes with small width or light color.

If the negative correlation between the driving current of the light emitting device 840 and the feedback pressure of the stylus is taken into consideration in this embodiment, the display manner of the touch sensitive display panel can be adjusted to the following: displaying the strokes with small width or light color when the touch sensitive display panel senses the intense light; displaying the strokes with large width or dark color when the touch sensitive display panel senses the dim light, so as to comply with users' habits. In other words, when a user exerts a strong touch force, the strokes with large width or dark color can be displayed; when the user exerts a weak touch force, the strokes with small width or light color can be displayed.

FIG. 9 is an equivalent circuit diagram of a stylus according to another embodiment of the invention. The main difference between the stylus of this embodiment and the stylus of the previous embodiment lies in that the DC power supply 850 of the stylus described in the previous embodiment is omitted herein, and that the pressure sensing material herein is a piezoelectric material 930. Thereby, an output voltage of the piezoelectric material 930 deformed by an external force can serve as the voltage supply of the light emitting device 940. The piezoelectric material 930, the light emitting device 940, and the resistor 960 are connected in parallel.

When a user exerts a large force with the stylus (i.e., the feedback pressure is large), the deformation of the piezoelectric material 930 is significant, and the output voltage generated thereby is large. Thus, the driving current flowing through the light emitting device 940 increases. That is to say, the driving current of the light emitting device 940 is positively correlated with the feedback pressure of the stylus. At this time, the intensity of light from the light emitting device 940 is large, and the touch sensitive display panel, when sensing the intense light, displays strokes with large width or dark color. When a user exerts a small force with the stylus (i.e., the feedback pressure is small), the deformation of the piezoelectric material 930 is insignificant, and the output voltage generated thereby is small. Thus, the driving current flowing through the light emitting device 940 decreases. At this time, the intensity of light from the light emitting device 940 is small, and the touch sensitive display panel, when sensing the dim light, displays strokes with small width or light color.

According to the previous embodiments, the electrical variation generated by the pressure sensing material (to which the feedback pressure is applied) is fed back to the intensity of light from the light emitting device of the stylus due to the design of the control module or the circuit loop, so as to adjust the display image on the touch sensitive display panel based on the intensity of light. As described in the previous embodiments, the electrical variation of the piezoresistive material or the piezoelectric material can be positively or negatively correlated with the pressure, upon which a structure of serial connection or parallel connection can be determined.

Nonetheless, in other embodiments of the invention, the electrical variation generated by the pressure sensing material (to which the feedback pressure is applied) may be fed back to the touch sensitive display panel through possible transmissions, so as to directly adjust the display image on the touch sensitive display panel based on the electrical variation. This design is described in the following embodiment.

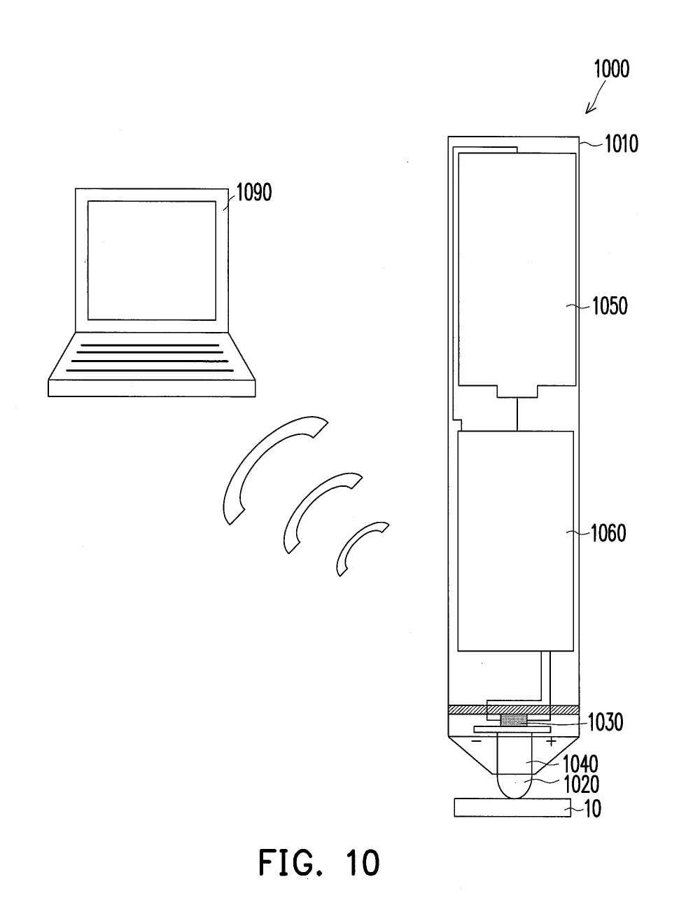

FIG. 10 illustrates a touch sensitive display system according to another embodiment of the invention. The touch sensitive display system includes a touch sensitive display panel 10, a stylus 1000, and a calculation apparatus 1090. The stylus 1000 includes a handle 1010, a head 1020, a pressure sensing material 1030, a light emitting device 1040, a power supply 1050, and a wireless transmission module 1060. The head 1020 is located at one end of the handle 1010 for touching the touch sensitive display panel 10 along a trace. The light emitting device 1040 is, for instance, an LED for emitting light to the touch sensitive display panel 10. The touch sensitive display panel 10 is suitable for sensing the light emitted from the light emitting device 1040 to display an image corresponding to the trace. The pressure sensing material 1030 is disposed in the handle 1010 for receiving a feedback pressure P generated by touching the touch sensitive display panel 10 with the head 1020. Besides, the pressure sensing material 1030, when receiving the feedback pressure P, is deformed and generates an electrical variation. The pressure sensing material 1030 of this embodiment is a piezoresistive material, for instance. That is to say, when an external force is exerted on the pressure sensing material 1030, and the pressure sensing material 1030 is deformed, the impedance of the pressure sensing material 1030 is varied. The wireless transmission module 1060 is electrically connected to the pressure sensing material 1030 for receiving the electrical variation (e.g., the impedance variation). The calculation apparatus 1090 is suitable for receiving the electrical variation (e.g., the impedance variation) from the wireless transmission module 1060 in a wireless manner and adjusting an appearance of the image according to the electrical variation (e.g., the impedance variation). For instance, the width of the line or the gray level of the line along the touch trace can be adjusted.

Namely, in this embodiment, the electrical variation generated by the pressure sensing material 1030 (to which the feedback pressure is applied) is transmitted by the wireless transmission module 1060 to the external calculation apparatus 1090 in a wireless manner. The calculation apparatus 1090, based on the received electrical variation, determines the magnitude of the force exerted by the user on the stylus 1000, i.e., the strokes, and thereby the calculation apparatus 1090 can adjust the image displayed on the touch sensitive display panel 10.

Certainly, the invention is not limited thereto. According to other embodiments of the invention, the pressure sensing material and the calculation apparatus can be connected through a wire, e.g., through a universal serial bus (USB) interface. The power supply is not limited to be in the stylus and can be replaced by an external power supply. What is more, the light emitting device 1040 in the stylus 1000 described in the previous embodiment may even be omitted under certain circumstances. That is to say, the stylus of this embodiment is not limited to be an optical stylus having the structure of “touch panel integration on glass”; instead, the stylus may also be an optical reflective stylus, a stylus having an out-cell type structure, a resistive stylus, a capacitive stylus, and so on. The head 1020 may be made of a material with high reflectivity, a conductive material, plastic, and so forth.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A stylus suitable for a touch sensitive display panel, the stylus comprising:
a handle;
a head located at one end of the handle for touching the touch sensitive display panel;
a pressure sensing material disposed in the handle for receiving a feedback pressure generated by touching the touch sensitive display panel with the head, wherein the pressure sensing material, when receiving the feedback pressure, is suitable for being deformed and generates an electrical variation; and
a light emitting device located in the handle for emitting light to the touch sensitive display panel, wherein the light emitting device is electrically connected to the pressure sensing material, and a driving current of the light emitting device responds to the electrical variation.

2. The stylus as recited in claim 1, wherein the pressure sensing material is a piezoresistive material, and the electrical variation is an impedance variation.

3. The stylus as recited in claim 2, wherein the piezoresistive material and the light emitting device are connected in series on a direct-current loop.

4. The stylus as recited in claim 2, wherein the piezoresistive material and the light emitting device are connected in parallel on a direct-current loop.

5. The stylus as recited in claim 1, wherein the pressure sensing material is a piezoelectric material, and the electrical variation is an output voltage variation.

6. The stylus as recited in claim 5, wherein the piezoelectric material and the light emitting device are connected in parallel.

7. The stylus as recited in claim 1, further comprising a control module located in the handle, wherein the control module is electrically connected to the light emitting device and the pressure sensing material for adjusting intensity of the light emitted by the light emitting device according to the electrical variation of the piezoelectric material.

8. The stylus as recited in claim 1, further comprising a direct current power supply electrically connected to the light emitting device.

9. A touch sensitive display system comprising:
a touch sensitive display panel having a photosensitive module; and
a stylus comprising:
a handle;
a head located at one end of the handle for touching the touch sensitive display panel along a trace;
a pressure sensing material disposed in the handle for receiving a feedback pressure generated by touching the touch sensitive display panel with the head, wherein the pressure sensing material, when receiving the feedback pressure, is suitable for being deformed and generates an electrical variation; and
a light emitting device located in the handle for emitting light to the touch sensitive display panel, wherein the photosensitive module is suitable for receiving the light, the touch sensitive display panel is suitable for displaying an image corresponding to the trace, the light emitting device is electrically connected to the pressure sensing material, a driving current of the light emitting device responds to the electrical variation, intensity of the light emitted by the light emitting device is changed together with a variation in magnitude of the driving current, and the photosensitive module is suitable for adjusting an appearance of the image based on the intensity of the light received by the photosensitive module.

10. The touch sensitive display system as recited in claim 9, wherein the pressure sensing material is a piezoresistive material, and the electrical variation is an impedance variation.

11. The touch sensitive display system as recited in claim 10, wherein the piezoresistive material and the light emitting device are connected in series on a direct-current loop.

12. The touch sensitive display system as recited in claim 10, wherein the piezoresistive material and the light emitting device are connected in parallel on a direct-current loop.

13. The touch sensitive display system as recited in claim 9, wherein the pressure sensing material is a piezoelectric material, and the electrical variation is an output voltage variation.

14. The touch sensitive display system as recited in claim 13, wherein the piezoelectric material and the light emitting device are connected in parallel.

15. The touch sensitive display system as recited in claim 9, wherein the stylus further comprises a control module located in the handle, the control module is electrically connected to the light emitting device and the pressure sensing material for adjusting intensity of the light emitted by the light emitting device according to the electrical variation of the pressure sensing material.

16. The touch sensitive display system as recited in claim 9, wherein the stylus further comprises a direct current power supply electrically connected to the light emitting device.

17. The touch sensitive display system as recited in claim 9, wherein the photosensitive module comprises a plurality of photo sensors respectively disposed in a plurality of pixel regions of the touch sensitive display panel.

18. The touch sensitive display system as recited in claim 9, wherein the image comprises a line along the trace.

19. The touch sensitive display system as recited in claim 18, wherein the photosensitive module adjusts the appearance of the image according to the intensity of the light received by the photosensitive module, and the appearance of the image comprises a width of the line or a gray level of the line.

20. A touch sensitive display method suitable for a touch sensitive display panel and a stylus, a pressure sensing material being disposed in the stylus, the stylus being suitable for touching the touch sensitive display panel along a trace, the touch sensitive display panel being suitable for sensing light emitted by the stylus and displaying an image corresponding to the trace, the touch sensitive display method comprising:
generating a feedback pressure by touching the touch sensitive display panel with the stylus to deform the pressure sensing material and generate an electrical variation;
coupling the electrical variation to a driving current of the light emitting device to adjust intensity of the light; and
adjusting an appearance of the image according to the intensity of the light.

21. The touch sensitive display method as recited in claim 20, wherein the pressure sensing material is a piezoresistive material, the electrical variation is an impedance variation, the piezoresistive material and the light emitting device are connected in series on a direct-current loop, wherein:
when the feedback pressure increases, impedance of the pressure sensing material decreases, the driving current increases, and the intensity of the light increases; and when the feedback pressure decreases, the impedance of the pressure sensing material increases, the driving current decreases, and the intensity of the light decreases.

22. The touch sensitive display method as recited in claim 20, wherein the pressure sensing material is a piezoresistive Material, the electrical variation is an impedance variation, the piezoresistive material and the light emitting device are connected in parallel on a direct-current loop, wherein:
when the feedback pressure increases, impedance of the pressure sensing material decreases, the driving current decreases, and the intensity of the light decreases; and
when the feedback pressure decreases, the impedance of the pressure sensing material increases, the driving current increases, and the intensity of the light increases.

23. The touch sensitive display method as recited in claim 20, wherein the pressure sensing material is a piezoelectric material, the electrical variation is an output voltage variation, the piezoelectric material and the light emitting device are connected in parallel, wherein:
when the feedback pressure increases, an output voltage of the pressure sensing material increases, the driving current increases, and the intensity of the light increases; and
when the feedback pressure decreases, the output voltage of the pressure sensing material decreases, the driving current decreases, and the intensity of the light decreases.

24. The touch sensitive display method as recited in claim 20, wherein a method of coupling the electrical variation to the driving current of the light emitting device to adjust the intensity of the light comprises:
receiving the electrical variation by a control module and outputting the driving current to the light emitting device according to the electrical variation, so as to the adjust the intensity of the light.

25. The touch sensitive display method as recited in claim 20, wherein the image comprises a line along the trace, and a method of adjusting the appearance of the image according to the intensity of the light comprises:
adjusting a width of the line or a gray level of the line according to the received intensity of the light.

26. The touch sensitive display method as recited in claim 25, wherein the greater the intensity of the light, the larger the width of the line, or the darker the line; and
the less the intensity of the light, the smaller the width of the line, or the lighter the light.

27. A touch sensitive display system comprising:
a touch sensitive display panel;
a stylus comprising:
a handle;
a head located at one end of the handle for touching the touch sensitive display panel along a trace, the touch sensitive display panel being suitable for displaying an image corresponding to the trace;
a pressure sensing material disposed in the handle for receiving a feedback pressure generated by touching the touch sensitive display panel with the head, wherein the pressure sensing material, when receiving the feedback pressure, is suitable for being deformed and generates an electrical variation; and
a transmission module electrically connected to the pressure sensing material for receiving the electrical variation; and
a calculation apparatus electrically connected to a touch sensitive display device, the calculation apparatus being suitable for receiving the electrical variation from the transmission module in a wireless manner and adjusting an appearance of the image according to the electrical variation.

28. The touch sensitive display system as recited in claim 27, wherein the pressure sensing material is a piezoresistive material, and the electrical variation is an impedance variation.

29. The touch sensitive display system as recited in claim 27, wherein the image comprises a line along the trace.

30. The touch sensitive display system as recited in claim 29, wherein the photosensitive module adjusts the appearance of the image according to intensity of light received by the photosensitive module, and the appearance of the image comprises a width of the line or a gray level of the line.

31. The touch sensitive display system as recited in claim 27, further comprising a light emitting device located in the handle for emitting light to the touch sensitive display panel.

32. The touch sensitive display system as recited in claim 27, wherein the transmission module comprises a wireless transmission module or a wire transmission module.
